(19) United States
(12) Patent Application Publication
(10) Pub. No.: US 2007/0235256 A1
(43) Pub. Date: Oct. 11, 2007

(54) Device for making a starter hole for a tree step

(76) Inventor: Richard M. Spencer, Mexico, NY (US)

Correspondence Address: JAMES RAY & ASSOCIATES, 2640 PITCAIRN ROAD, MONROEVILLE, PA, 15146, US

(21) Appl. No.: 11/732,259

(22) Filed: Apr. 3, 2007

Related U.S. Application Data
(60) Provisional application No. 60/789,287, filed on Apr. 5, 2006.

(51) Int. Cl. E06C 9/00

(52) U.S. Cl. 182/92

(57) ABSTRACT

A device for making starter hole for a tree step includes a weighted hammer head with a spike extending from a surface thereof and a handle extending from the head in a direction perpendicular to the axis of the spike. A retaining strap is attached to the handle. A user will swing the handle to punch holes in a tree trunk into which the screw end of a tree step is inserted.

### CROSS REFERENCE TO RELATED APPLICATION

This patent application is related to and claims priority from U.S. Provisional Patent Application Ser. No. 60/789,287 filed Apr. 5, 2007.

### BACKGROUND OF THE INVENTION

To hunt deer and other large animals, hunters will position themselves in a tree so that ground vegetation will not interfere with spotting and citing on a target. To climb a tree, a hunter will insert a plurality of tree steps spaced at regular intervals of approximately one foot apart upward along the trunk of the tree. Once installed, the hunter can climb the tree by stepping on steps adjacent his feet and grasping with his hands steps adjacent his arms.

Although the provision of tree steps simplifies the process of climbing a tree once the steps are installed, the installation of a set of tree steps often presents considerable difficulty. Tree steps typically have a screw connector end having a longitudinal axis, a support bar having one end connected to the screw and extending perpendicular thereto, and a step bar extending from the opposite end of the support for extending generally parallel to the axis of the screw. A typical climbing step is depicted and described in Bergsten U.S. Pat. No. 3,298,459, Melcher U.S. Pat. No. 3,380,697 and in Cross U.S. Pat. No. 5,899,124. Even though the threaded screw of tree steps are manufactured to self-start so that the tree step can be installed to the trunk of the tree without a starter hole, in reality the trunk of a tree is an irregularly shaped hard surface that generally does not readily receive a threaded screw of a tree step. It is desirable, therefore, that a hunter can carry with him a second tool with which he can drill or punch a starter hole in the trunk of a tree for receiving the screw of a tree step. The use of customary tools, such as drills and knives, however are difficult to use by a hunter who is required to retain a grip on the tree to prevent from falling from a position as high as twenty feet above the ground. It would be desirable, therefore, to provide a tool that would form a starter hole for receiving the screw of a tree step and could be easily used and stored by a hunter who is ascending a tree and installing tree steps as he goes.

### SUMMARY OF THE INVENTION

Briefly, the present invention is embodied in a device for making a starter hole for a tree step that includes a weighted hammer head having a tapered spike extending from one surface thereof. A handle extends from the hammer head in a direction that is perpendicular to the longitudinal axis of the spike such that a user can grasp the handle to swing the head with the spike directed toward the tree. On impact, the spike will become embedded within the trunk of the tree, after which the user can manipulate the handle to release the spike from the tree leaving a hole suitable for receiving the screw end of a tree step.

In the preferred embodiment, a strap suitable for attaching to the belt or over the shoulder of a climber is attached to the handle of the hammer such that both hands of the user are available for other purposes while the hammer is not in use.

To utilize the invention, a hunter, or any other person desiring to climb a post or tree will first provide himself with a device in accordance with the invention including a weighted hammer head having a spike extending therefrom and a handle extending from the hammer head that is generally perpendicular to the longitudinal axis of the spike. When the user desires to insert a tree step at a given elevation on the post or tree trunk, the user will grasp the handle of the device and swing the head causing the spike to be embedded into the tree trunk or post at the desired elevation. Thereafter, the user will manipulate the handle to free the spike from the trunk or post, and then, using a conventional tree step, insert the screw attachment end of the tree step in the hole formed by the spike. The user will then turn the screw until the tree step is firmly attached to the trunk or post. Thereafter, the user will again use the device to puncture another hole further up the trunk of the tree for receiving the next tree step.

### BRIEF DESCRIPTION OF THE DRAWINGS

A better understanding of the present invention will be had after a reading of the following detailed description taken in conjunction with the drawings wherein:

FIG. 1 is a side elevational view of a device in accordance with the present invention;

FIG. 2 is a fragmentary end view of the device of FIG. 1 showing the spike portion thereof and,

FIG. 3 is a schematic drawing of the steps followed by a user of the invention shown in FIG. 1 to insert a tree step in the trunk of a tree.

### DETAILED DESCRIPTION OF PREFERRED EMBODIMENT

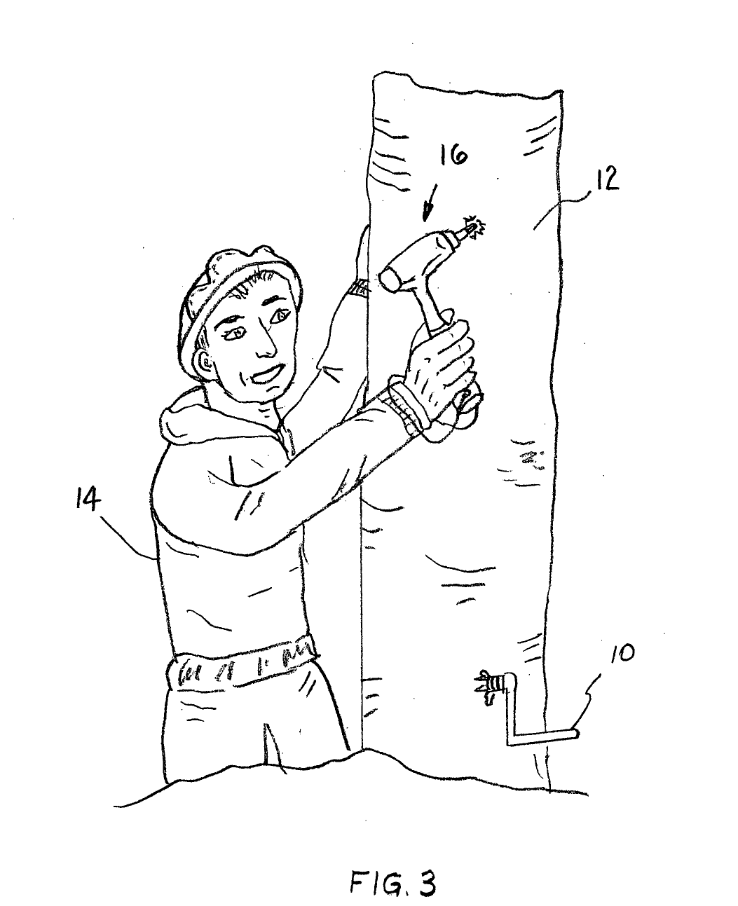

Referring to FIGS. 1, 2 and 3, to insert a tree step 10 of the type commonly known in the art into the trunk of a tree 12, a climber 14 will employ a device 16 in accordance with the present invention.

The device 16 is essentially a hammer having an enlarged metallic head 18. Extending from one surface of the head 18 is a tapered spike 20 having a longitudinal axis 22. The tapered spike 20 is preferably made of a hardened steel cylindrical bar having a diameter of three-eighths inch to seven-sixteenths inch and an overall length of about one and one-half inches. The outer half 21 of the steel bar is machined into a tapered four sided pyramid with the sides 24, 25, 26, 27 positioned at ninety degrees to adjacent sides. The spike 20 is welded to the generally planar striking surface of the metal head 18.

Extending in a direction generally perpendicular to the axis 22 of the spike 20 is an elongate handle 32 having an overall length of about ten inches. Finally, attached to the distal end of the handle 32 is a flexible strap 34 suitable for attaching to the belt or wrist of a climber 14. Alternately, where the strap 34 is configured as a loop, a climber may position the loop over a shoulder or around his neck such that he may carry the device 16 and climb the tree trunk 12 using both of his hands.

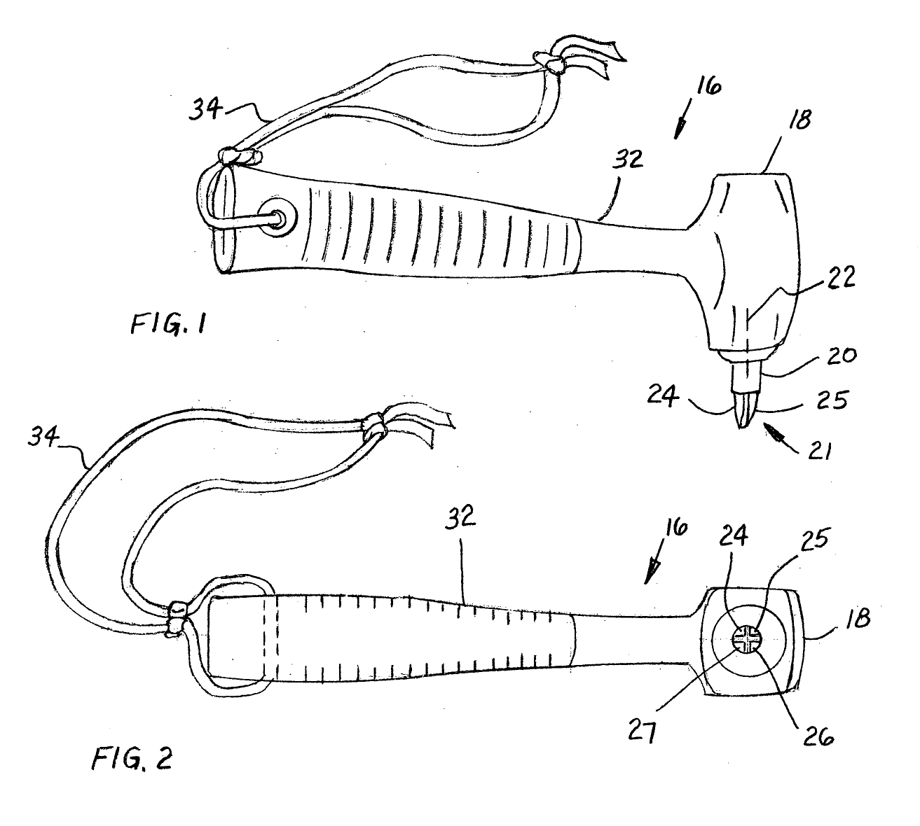

Referring to FIG. 2, to employ the device, the climber 14 will position himself on the ground, or partially up the trunk so that he can readily reach the position at which one or more additional tree steps 10 should be inserted. Thereafter, the climber 14 will grasp the handle 32 of the device 16 and swing the head 18 toward the tree trunk 12 with the spike 20 directed toward the tree trunk 12. The weight of the hammer head 18 and the force applied thereto as it is swung by the climber 14 will drive the tapered forward end of the spike 20 into the surface of the tree trunk 12.

Thereafter, the climber 14 will manipulate the handle 32 to loosen the spike 20 from the tree trunk 12. Once the spike 20 is removed, a hole 37 will remain in the tree trunk. Where the climber is positioned sufficiently high relative to the first hole 37 punched by the device 16, he may swing the device 16 a second or a third time and punch additional holes 37 spaced along the tree trunk 12 for receiving a second or a third tree step 10.

The climber will carry with him a plurality of tree steps 10 of the type well known in the art. A tree step 10 includes a tapered screw-type attachment device 35 having a pointed distal end and a larger diameter base. Extending perpendicular from the base of the screw connector 35 is a support arm 36 and extending perpendicular from the opposite end of the support arm 36 is a step bar 38. Such tree step connectors 10 are disclosed in Bergsten U.S. Pat. No. 3,298,459, Melcher U.S. Pat. No. 3,380,697, and Cross U.S. Pat. No. 5,899,124, all of which are incorporated herein by reference.

Thereafter, the climber 14 will insert the screw 35 of the tree step 10 into the hole 37 in the tree trunk 12 left by the spike 20 and then grasp the step bar 38 with one hand and use it as a crank to turn the screw 35 into the tree trunk 12.

In similar fashion, the climber will insert tree steps 10 into a plurality of spaced apart starter holes that extend up the tree trunk 12 until the desired elevation is reached. When the device 10 is not in use, the climber 14 will allow the device to dangle from his belt or shoulder by the strap 34.

While the present invention has been described with respect to a specific embodiment, it will be appreciated that many modifications and variations can be made without departing from the true spirit and scope of the invention. It is therefore the intent of the appended claims to cover all such modifications and variations that fall within in the true spirit and scope of the invention.

What is claimed:

1. The method of installing a step into a tree comprising the steps of
providing a starter tool in the form of a hammer having a weighted head, said weighted head having a spike extending there from, said spike having a longitudinal axis, said starter tool having an elongate handle extending from said head, said handle generally perpendicular to said longitudinal axis of said spike,
grasping said starter tool by said handle and swinging said weighted head to drive said spike into said tree,
removing said spike from said tree, leaving a hole therein,
providing a step having a screw attachment, and
inserting said screw attachment into said hole and turning said screw attachment to install said step.

2. The method of claim 1 wherein
said starter tool has a strap extending therefrom and said method includes the further step of attaching said strap to an installer's body.

3. A starter tool for starting a hole for receiving a threaded screw comprises
a hammer having a weighted head,
said weighted head having a spike extending there from,
said spike having a longitudinal axis,
said starter tool having an elongate handle extending from said head, and
said handle generally perpendicular to said longitudinal axis of said spike.
